(19) United States
(12) Patent Application Publication
(10) Pub. No.: US 2015/0134395 A1
(43) Pub. Date: May 14, 2015

(54) PLANNING SYSTEM FOR CROP PRODUCTION, PLANNING METHOD FOR CROP PRODUCTION, AND NON-TRANSITORY COMPUTER-READABLE RECORDING MEDIUM

(71) Applicant: INSTITUTE FOR INFORMATION INDUSTRY, Taipei City (TW)

(72) Inventors: CHAO-LUNG YANG, TAIPEI CITY (TW); SHIN-JIE HUANG, TAINAN CITY (TW); PO-CHENG HUANG, YUNLIN COUNTY (TW); MAO-YUAN CHIN, PINGTUNG COUNTY (TW)

(73) Assignee: INSTITUTE FOR INFORMATION INDUSTRY, Taipei City (TW)

(21) Appl. No.: 14/098,855

(22) Filed: Dec. 6, 2013

(30) Foreign Application Priority Data
Nov. 14, 2013 (TW) 102141536

(51) Int. Cl. G06Q 10/06; G06Q 50/02; G06Q 30/02

(52) U.S. Cl. CPC G06Q 10/06313; G06Q 30/0201; G06Q 50/02
USPC 705/7.23

(57) ABSTRACT

The present invention relates generally to a planning system for crop production, a planning method for crop production, and a non-transitory computer-readable recording medium. The system comprises an analyzing module, a grouping module, and a scheduling module. The analyzing module analyzes historical prices of each crop, and produces price feature information of each crop. The grouping module groups the plurality of crops by similar price feature information according to the price feature information of each crop into a plurality of crop groups. Then at least two crop groups are selected from the plurality of crop groups as a planning group. The price feature information for the plurality of crops in the planning group have a complementary relationship. The scheduling module selects at least a crop from the plurality of crops in each crop group of the planning group according to planting information of each crop and produces a plan.

### FIELD OF THE INVENTION

The present invention relates generally to a planning system for crop production, a planning method for crop production, and a non-transitory computer-readable recording medium. The present invention particularly relates to a planning system for crop production, a planning method for crop production, and a non-transitory computer-readable recording medium used for performing production planning for a plurality of crops according to the historical prices of crops.

### BACKGROUND OF THE INVENTION

Agricultural products are necessities for people's livelihood; they are also an important source of farmers' income. Currently, fast technological advancement and rapid climate change in recent years have impacted significantly on the global agriculture, influencing the yields and varying the prices of agricultural products. Not only the profits of farmers are influenced, consumers' rights and interests are also influenced. The prices and yields of agricultural products vary according to the season, climate, origin of production, import and export, and consumers' habits. Besides, different from general commercial products, agricultural products are relatively unstable in characteristics, yields, and quality, leading to substantial variations in their prices. Moreover, because the demand and supply of agricultural products lack elasticity and farmers usually cannot command effectively the price and yield information in the market, it happens frequently in each year that the prices of agricultural products collapse due to farmers planting the same agricultural products or oversupply of agricultural products.

Accordingly, the present invention provides a planning system for crop production, a planning method for crop production, and a non-transitory computer-readable recording medium which uses a computer to load an instruction set for executing a planning method for crop production according to the historical prices for acquiring the plan for crop production with profits satisfying farmers' expectation and avoiding the problem described above.

### SUMMARY

An objective of the present invention is to provide a planning system for crop production, a planning method for crop production, and a non-transitory computer-readable recording medium. The present invention analyzes historical prices of each crop, groups crops according to the price feature information, selects the groups having a complementary relationship in the price feature information , and selects the crops for performing planning and scheduling. Because the price feature information of the selected groups are complementary, high price points in the groups fall at different times. By planning and scheduling according to the present invention, the plan for crop production can give better profits. Thereby, price collapse of agricultural products due to farmers planting the same agricultural products or oversupply of agricultural products can be avoided.

For achieving the objective of effect described above, the present invention discloses a planning system for crop production used for performing production planning on a plurality of crops and comprising an analyzing module, a grouping module and a scheduling module. The analyzing module analyzes historical prices of each crop, and produces price feature information of each crop. The price feature information includes a plurality of prices of each crop in at least a period. The grouping module groups the plurality of crops by similar price feature information according to the price feature information of each crop into a plurality of crop groups. Then at least two crop groups are selected from the plurality of crop groups as a planning group. The plurality pieces of price feature information for the plurality of crops in the planning group have a complementary relationship. The scheduling module selects at least a crop from the plurality of crops in each crop group of the planning group according to planting information of each crop and produces a plan for crop production.

The present invention discloses a planning method for crop production, which comprises steps of analyzing historical prices of each crop, and producing price feature information of each crop, where the price feature information includes a plurality of prices of each crop in at least a period; grouping the plurality of crops by similar price feature information according to the price feature information of each crop and producing a plurality of crop groups, selecting at least two crop groups from the plurality of crop groups as a planning group, wherein the plurality pieces of price feature information for the plurality of crops in the planning group have a complementary relationship; and selecting at least a crop from the plurality of crops of each crop group in the planning group according to planting information of each crop and producing a plan for crop production.

The present invention further discloses a non-transitory computer-readable recording medium, which uses a computer to load an instruction set for executing a planning method for crop production. The planning method for crop production comprises steps of analyzing historical prices of each crop, and producing price feature information of each crop, where the price feature information includes a plurality of prices of each crop in at least a period; grouping the plurality of crops by similar price feature information according to the price feature information of each crop and producing a plurality of crop groups, selecting at least two crop groups from the plurality of crop groups as a planning group, wherein the plurality pieces of price feature information for the plurality of crops in the planning group have a complementary relationship; and selecting at least a crop from the plurality of crops in each crop group of the planning group according to planting information of each crop and producing a plan for crop production.

### BRIEF DESCRIPTION OF THE DRAWINGS

FIG. 1 shows a block diagram of the planning system for crop production according to the first embodiment of the present invention;

FIG. 2 shows a flowchart of the planning method for crop production according to the first embodiment of the present invention;

FIG. 3 shows a price variation diagram of a crop according to the first embodiment of the present invention;

FIG. 4 shows a schematic diagram of the price feature information according to the first embodiment of the present invention;

FIG. 5 shows another schematic diagram of the price feature information according to the first embodiment of the present invention; and

FIG. 6 shows a block diagram of the planning system for crop production according to the second embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

At present, there is no production planning system for crops. Thereby, farmers usually cannot command effectively the price and yield information in the market; it happens frequently in each year that the prices of agricultural products collapse due to farmers planting the same agricultural products or oversupply of agricultural products. Accordingly, the present invention provides a planning system for crop production, a planning method for crop production, and a non-transitory computer-readable recording medium, which can analyze, group, and schedule according to historical prices of crops and perform planning for giving a plan for crop production having preferred profits and avoiding the problem described above.

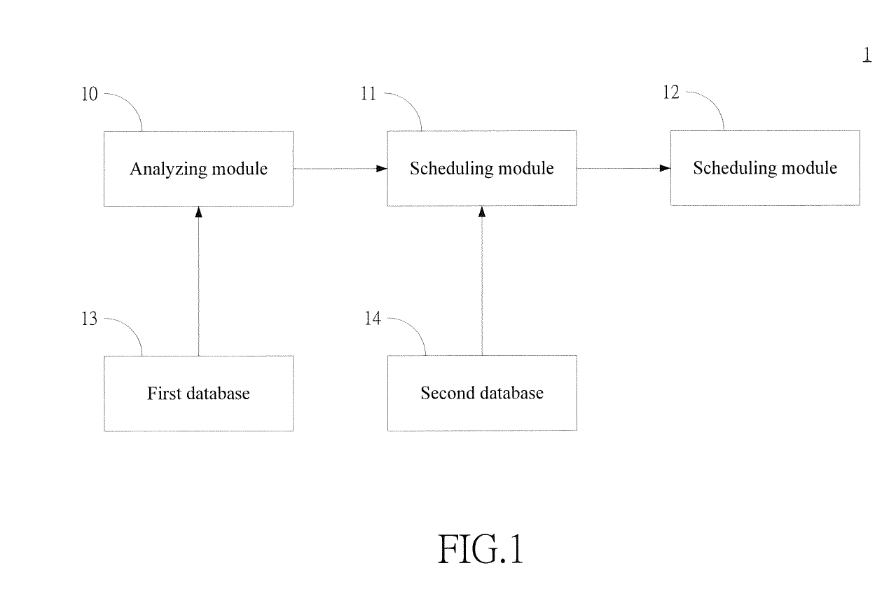

Please refer to FIG. 1, which shows a block diagram of the planning system for crop production according to the first embodiment of the present invention. As shown in the figure, the present embodiment provides a planning system for crop production 1 used for performing production planning for a plurality of crops and mainly comprising analyzing module 10, a grouping module 11, and a scheduling module 12. Furthermore, the planning system for crop production 1 can comprise a first database 13 and a second database 14. Alternatively, the first and second databases 13, 14 can be disposed outside and linked via a communication network. The first database 13 is used for recording and storing historical prices of each crop. The historical prices can be the prices of a crop corresponding to several periods, such as within a day, a week, a month, a season, or the whole, of a year. For example, the first database 13 can record the daily, weekly, or monthly (period) prices of cucumber (crop) between 1995 and 2012 as the historical prices. The second database 14 is used for recording and storing planting information of each crop. The planting information can be at least one of a growth cycle of each crop, a suitable season for planting each crop, a suitable environment for planting each crop, a planting cost of each crop, a production and sale plan, allocation of human resources, and a space effciency. The first database 13 is connected with the analyzing module 10 and provides the historical prices of each crop for analysis. The second database 14 is connected with the scheduling module 12 and provides the planting information of each crop to the scheduling module 12.

The analyzing module 10 according to the present embodiment analyzes the historical prices of each crop provided by the first database 13 and produces price feature information of each crop. Then, the grouping module 11 groups the plurality of crops by similar price feature information according to the price feature information of each crop into a plurality of crop groups. Next, select at least two crop groups from the plurality of crop groups as a planning group, wherein the plurality pieces of price feature information for the plurality of crops in the planning group have a complementary relationship. Finally, select at least a crop from the plurality of crops in each crop group of the planning group and produce a planfor crop production.

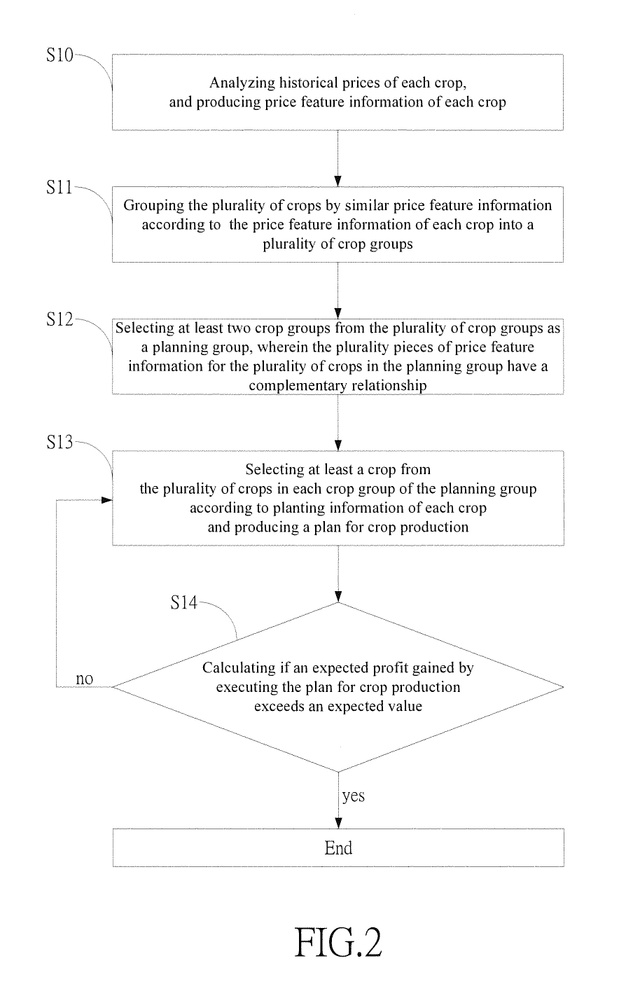

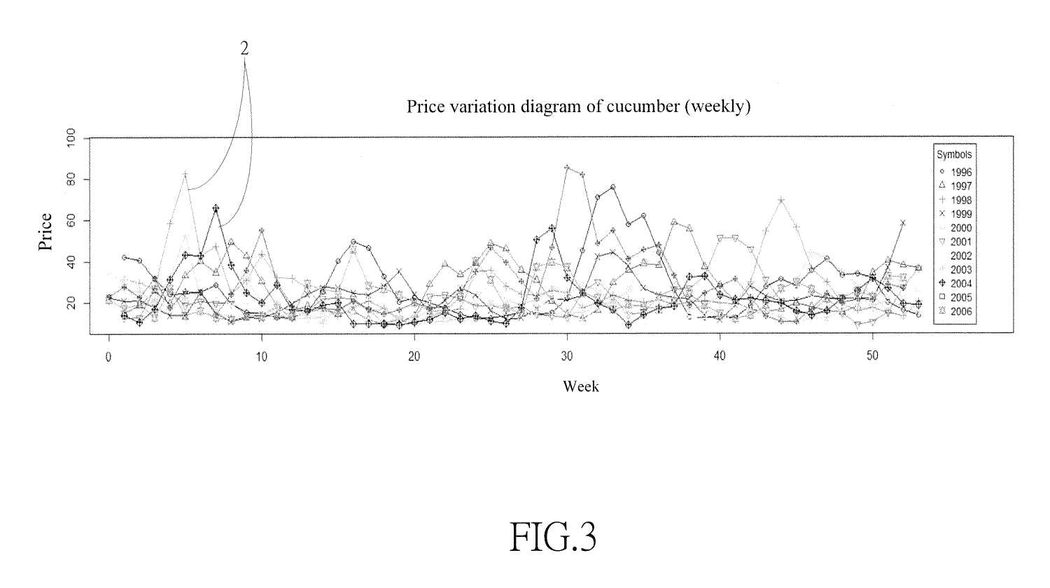

Please refer to FIG. 2, which shows a flowchart of the planning method for crop production according to the first embodiment of the present invention. As shown in the figure, in the following, the planning system for crop production 1 is used for performing the production planning method on a plurality of crops. According to the crop planning method of the present embodiment, the step S10 is first executed for analyzing the historical prices of each crop and producing price feature information of each crop. In some embodiments, the analyzing module 10 can receive the historical prices of each crop provided by the first database 13 for analysis. The analyzing module 10 can plot the historical prices of each crop as a plurality of price curves and form a price variation diagram. Please refer to FIG. 3 concurrently. FIG. 3 shows a price variation diagram of a crop according to the first embodiment of the present invention. As shown in the figure, FIG. 3 shows the price variation diagram of cucumber (crop) including a plurality of price variation curves 2. Each price variation curve 2 represents the price variation of cucumber (crop) in a certain year. Of course, the historical prices of each crop cannot be a diagram. Instead, it can be look-up table recording the prices of each crop in every period of each year.

No matter the form in which the historical prices of each crop is presented, the analyzing module 10 can analyze the historical prices of each crop and produce price feature information of each crop. The price feature information includes a plurality of prices in at least a period. The prices can be extracted directly from the historical prices. In addition, the plurality of prices of the price feature information can be discontinuous. For example, the price feature information includes the prices of March, June, September, and December (period). It is only required that the plurality of prices can judge the times of high and low price points. Certainly, the plurality of prices of the price feature information can be continuous. For example, the price feature information includes the prices of every month (period). Besides, a price variation curve can be generated according to the plurality of prices. The price feature information described above can be extracted directly from the historical prices. For example, a price curve can be selected directly from the price variation diagram of the historical prices and used as the price variation curve. Alternatively, the price of a certain period in a certain year can be extracted directly from the look-up table of the historical prices. Alternatively, a principal component analysis method can be used for analyzing the historical prices of each crop and giving the most representative prices in at least a period, which can be used as the price feature information.

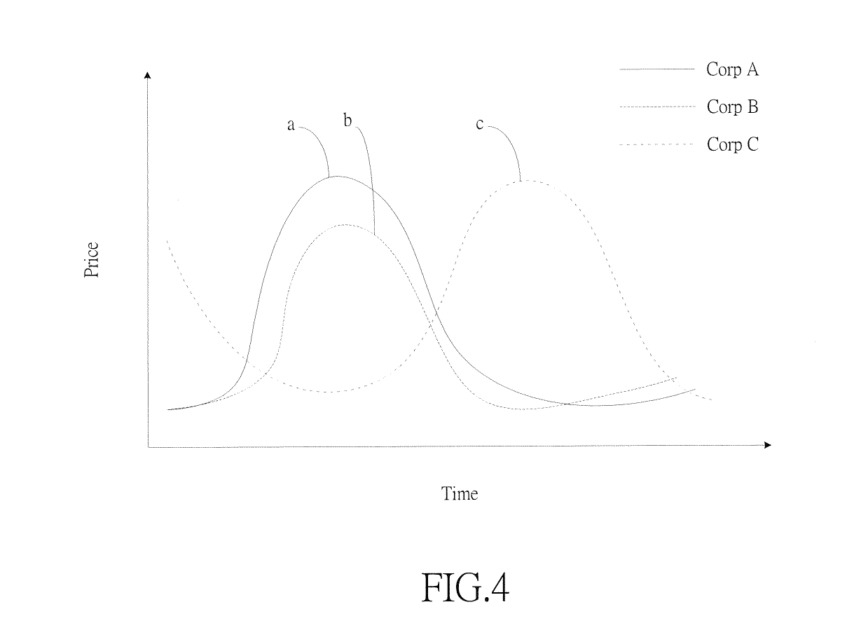

Next, the step S11 is executed. The grouping module 11 groups the plurality of crops by similar price feature information according to the price feature information of each crop into a plurality of crop groups. In some embodiments, if the plurality pieces of price feature information are price variation curves, respectively, grouping is performed by comparing the degree of similarity among the price variation curves of crops. Please refer to FIG. 4 concurrently. FIG. 4 shows a schematic diagram of the price feature information according to the first embodiment of the present invention, and includes the price feature information a of the crop A, the price feature information b of the crop B, and the price feature information c of the crop C, all being price variation curves. Apparently, the degree of similarity between the two price variation curves of the price feature information a of the crop A and the price feature information b of the crop B is higher; the degree of similarity between the two price variation curves of the price feature information c of the crop C and the price feature information a of the crop A, and the degree of similarity between the two price variation curves of the price feature information c of the crop C and the price feature information b of the crop B are both lower. Thereby, the crop A and the crop B are grouped to a crop group and the crop C is in another crop group.

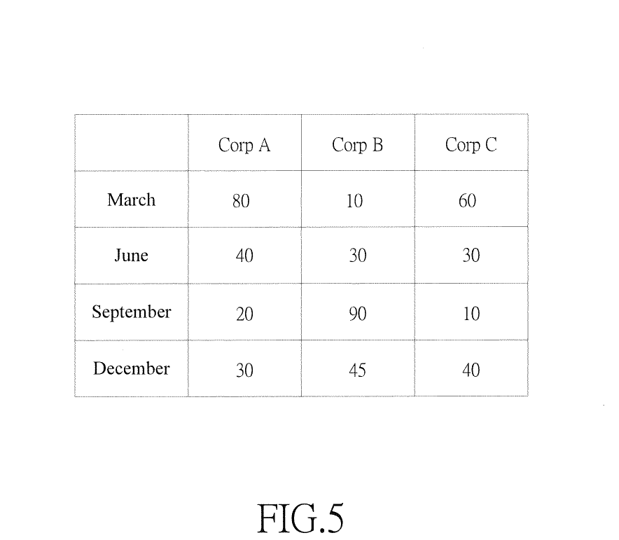

If the plurality pieces of price feature information are prices in at least a period, respectively, grouping is performed by comparing the degree of similarity among the prices of crops in at least a period. Please refer to FIG. 5 concurrently. FIG. 5 shows another schematic diagram of the price feature information according to the first embodiment of the present invention, and includes the plurality pieces of price feature information of the crop A, the crop B, and the crop C, all being the prices in at least a period. Each piece of the price feature information includes the prices in March and September. The plurality pieces of price feature information of the crop A and the crop C both show that the prices of the crops A, C are at high price points in March (period) and at low price points in September (period); the price of the crop B is at low price points in March and at high price points in September. Accordingly, the crop A and the crop C are grouped to a crop group and the crop B is in another crop group. To conclude, the grouping of the plurality of crops according to the present embodiment can be performed by using a model-based method.

Crops in the same crop group have the same properties. For example, referring again to FIG. 5, the prices of the crops A, C are at the high price pints in the same period. Alternatively, the plurality pieces of price feature information of the plurality of crops show that the variation of the prices of the plurality of crops is larger. Thereby, the property of the same crop group can be judged according to the plurality pieces of price feature information of the plurality of crops. After the step S11 is completed, the step S12 is executed subsequently. The grouping module 11 selects at least two crop groups from the plurality of crop groups as a planning group, wherein the plurality pieces of price feature information for the plurality of crops in the planning group have a complementary relationship. In the above description, it has been mentioned that the plurality pieces of price feature information of the plurality of crops in each crop group can represent the property of the crop group. In addition, the plurality pieces of price feature information of the plurality of crops in the same crop group are similar; one of the plurality pieces of price feature information can be selected to represent the crop group. In other embodiments, several representative pieces of price feature information of crops can be integrated, averaged, and weightedly calculated for giving a piece of price feature information representative of the crop group.

In the following, an example is given for describing that the plurality pieces of price feature information of each crop group in the same planning group have a complementary relationship. For example, the planning group set includes a crop group X and a crop group Y. The representative crop of the crop X is the crop C. The price feature information of the crop C shows that the prices of the crops in the crop group X are at high price points in the winter. The representative crop of the crop Y is the crop A. The price feature information of the crop A shows that the prices of the crops in the crop group Y are at high price points in the summer. Accordingly, the plurality of crops in the crop group X can be arranged to be harvested in the winter, and the plurality of crops in the crop group Y can be arranged to be harvested in the summer. Thereby, the prices of the crops harvested in the summer and in the winter can be located at or close to high price points for increasing the overall profits. Hence, the crop group X and the crop group Y have the complementary relationship. According to another embodiment, the price feature information of the crop group Z shows that the crops in the group are produced in a short cycle and have stable prices. Then the crop group Z can be arranged between the crop group X and the crop group Y. Thereby, the plurality pieces of price feature information of the crop group X, Y, Z can be regarded as having complementary relationship. In other words, the complementary relationship means that period corresponding to high price points of the plurality pieces of price feature information for each crop group in the same planning group is different from other crop groups in said planning group.

After the step S12 is completed, the step S13 is executed next. The scheduling module 12 selects at least a crop from the plurality of crops in each crop group in the planning group according to planting information of each crop provided by the second database 14 for scheduling and produces a plan for crop production. The planting information of each crop includes at least one of the growth cycle of each crop, the suitable season for planting crop, the suitable environment for planting crop, the planting cost, the production and sales plan, the allocation of human resources, and the space effciency. According to the price feature information of each crop group in the planning group, it is known when to harvest the plurality of crops in each crop group and the prices will be located at high price points. Nonetheless, it is also required to match the growth cycles of the plurality of crops in each crop group so that the suitable crop can be selected from the plurality of crops in each crop group. Then the selected crops from each crop group are scheduled to give the plan for crop production. Consequently, when the selected plurality of crops are harvested, their prices will be located at high price points. Moreover, the crops selected from each crop group can consider concurrently the suitable season for planting crop, the suitable environment for planting crop, the planting cost, the production and sales plan, the allocation of human resources, or the space effciency.

After the plan for crop production is given, the step S14 is executed. The scheduling module 12 calculates an expected profit gained by executing the plan for crop production and judges if the expected profit exceeds an expected value according to the plan for crop production and the price feature information of each scheduled crop to be planted (namely, the price feature information of each crop gained in the step S10). The expected value is set by the planner. If the expected profit exceeds the expected value, the plan for crop production can be executed. If the expected profit is lower than the expected value, at least a crop to be planted in the plan for crop production can be replaced. That is to say, the step S13 is re-executed for giving a new plan for crop production. Then the step S14 is executed for verifying if the expected profit acquired according to the new plan for crop production exceeds the expected value. After the verification of the plan for crop production in the step S14, a better profit gained by executing the plan for crop production can be guaranteed.

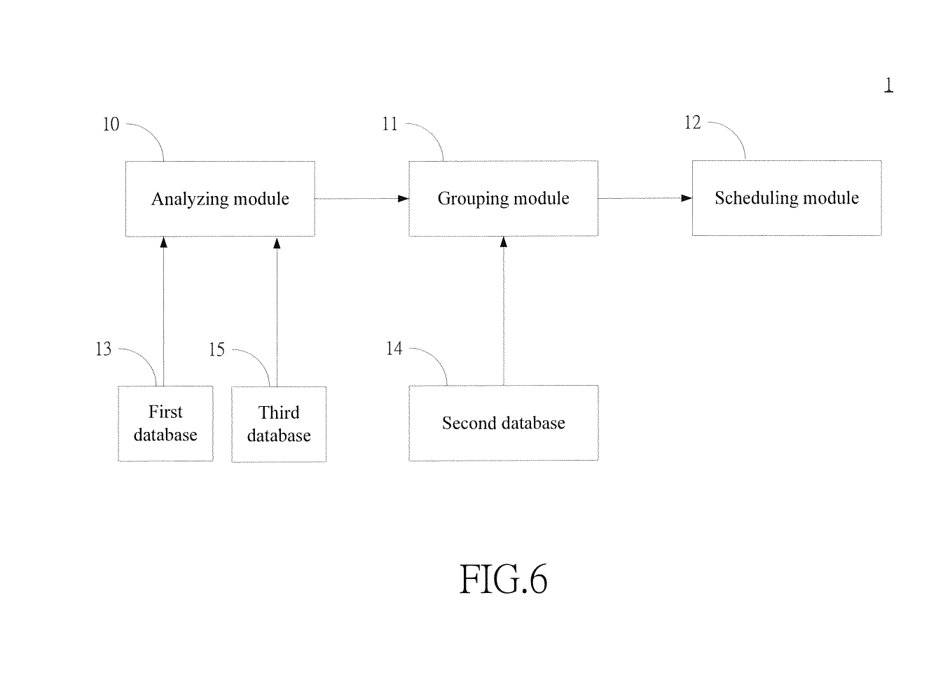

Please refer to FIG. 6, which shows a block diagram of the planning system for crop production according to the second embodiment of the present invention. As shown in the figure, the planning system for crop production 1 according to the present embodiment further comprises a third database 15 recording and storing historical weather information. The historical weather information records the daily weather information such as the temperature and rainfall in every year. The third database 15 is connected with the analyzing module 10. When the analyzing module 10 analyzes the historical prices of each crop, the third database 15 provides the historical weather information to the analyzing module 10, which forecasts the weather of this year according to the historical weather information for producing weather prediction information. Then the analyzing module 10 analyzes the historical prices of each crop according to the weather prediction information for producing the price feature information of each crop. Because the weather changes significantly yearly, by referring to the weather prediction information of this year for analyzing the historical prices of each crop, the price feature information of crop can be given more accurately and thus improving the accuracy of production planning for crops. The present invention further provides a non-transitory computer-readable recording medium. A computer loads an instruction set for executing the planning method for crop production described above.

To sum up, the present invention provides a planning system for crop production, a planning method for crop production, and a non-transitory computer-readable recording medium. The planning method for crop production according to the present invention performs analyzing, and grouping according to the historical prices of each crop. The plan for crop production can give better profits. Thereby, price collapse of agricultural products due to farmers planting the same agricultural products or oversupply of agricultural products can be avoided. Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. A planning system for crop production, used for performing production plan on a plurality of crops, comprising:
an analyzing module, analyzing historical prices of each crop, and producing price feature information of each crop, and said price feature information including a plurality of prices of each crop in at least a period;
a grouping module, grouping said plurality of crops by similar price feature information according to said price feature information of each crop into a plurality of crop groups, selecting at least two crop groups from said plurality of crop groups as a planning group, wherein said plurality pieces of price feature information for said plurality of crops in said planning group have a complementary relationship; and
a scheduling module, selecting at least a crop from said plurality of crops in each crop group of said planning group according to planting information of each crop, and producing a plan for crop production.

2. The planning system for crop production of claim 1, wherein said complementary relationship means that period corresponding to high price points of said plurality of prices of said price feature information for each crop group in said planning group is different from other crop groups in said planning group.

3. The planning system for crop production of claim 1, wherein said price feature information of each crop is a price variation curve generated according to the prices in at least a period.

4. The planning system for crop production of claim 1, and further comprising a first database, providing said historical prices of each crop to said analyzing module, wherein said historical prices are the prices of said crop corresponding to several periods of every year.

5. The planning system for crop production of claim 1, and further comprising a second database, providing said planting information of each crop to said scheduling module.

6. The planning system for crop production of claim 1, wherein said planting information of each crop includes at least one of a growth cycle of each crop, a suitable season for planting each crop, a suitable environment for planting each crop, a planting cost, a production and sale plan, allocation of human resources, and a space efficiency.

7. The planning system for crop production of claim 1, wherein said planting information of each crop is a growth cycle of each crop; said plan for crop production is generated by scheduling said plurality of crops selected from said plurality of crops in each crop group according to the growth cycle of each crop and the prices of said selected plurality of crops are located at high price points when harvesting.

8. The planning system for crop production of claim 1, wherein said analyzing module analyzes historical weather information for producing weather prediction information, and analyzing said historical prices of each crop according to said weather prediction information.

9. The planning system for crop production of claim 1, wherein said scheduling module further calculates an expected profit gained by executing said plan for crop production according to said plan for crop production and said price feature information of each said crop to be planted.

10. A planning method for crop production, comprising steps of:
analyzing historical prices of each crop, and producing price feature information of each crop, and said price feature information including a plurality of prices of each crop in at least a period;
grouping said plurality of crops by similar price feature information according to said price feature information of each crop into a plurality of crop groups, selecting at least two crop groups from said plurality of crop groups as a planning group, wherein said plurality pieces of price feature information for said plurality of crops in said planning group have a complementary relationship; and
selecting at least a crop from said plurality of crops in each crop group of said planning group according to planting information of each crop, and producing a plan for crop production.

11. The planning method for crop production of claim 10, wherein said complementary relationship means that period corresponding to high price points of said plurality of prices of said price feature information for each crop group in said planning group is different from other crop groups in said planning group.

12. The planning method for crop production of claim 10, wherein said price feature information of each crop is a price variation curve generated according to the prices in at least a period.

13. The planning method for crop production of claim 10, wherein said planting information of each crop includes at least one of a growth cycle of each crop, a suitable season for planting each crop, a suitable environment for planting each crop, a planting cost, a production and sales plan, allocation of human resources, and a space effciency.

14. The planning method for crop production of claim 10, wherein said planting information of each crop is a growth cycle of each crop; said plan for crop production is generated by scheduling said plurality of crops selected from said plurality of crops in each crop group according to the growth cycle of each crop and the prices of said selected plurality of crops are located at high price points when harvesting.

15. The planning method for crop production of claim 12, wherein step of analyzing said historical prices of each crop further comprises steps of:
analyzing historical weather information for producing weather prediction information; and
analyzing said historical prices of each crop according to said weather prediction information for producing said price feature information of each crop.

16. The planning method for crop production of claim 10, and further comprising a step of calculating an expected profit gained by executing said plan for crop production according to said plan for crop production and said price feature information of each said crop to be planted and judging if said expected profit exceeds an expected value.

17. The planning method for crop production of claim 10, wherein said step of analyzing said historical prices of each crop uses a principal component analysis method for analyzing, and said step of grouping said plurality of crops by similar price feature information according to said price feature information of each crop uses a model-based method for grouping.

18. A non-transitory computer-readable recording medium, loading an instruction set via a computer for executing a planning method for crop production comprising steps of:
analyzing historical prices of each crop, and producing price feature information of each crop, and said price feature information including a plurality of prices of each crop in at least a period;
grouping said plurality of crops by similar price feature information according to said price feature information of each crop into a plurality of crop groups, selecting at least two crop groups from said plurality of crop groups as a planning group, wherein said plurality pieces of price feature information for said plurality of crops in said planning group have a complementary relationship; and
selecting at least a crop from said plurality of crops in each crop group of said planning group according to planting information of each crop, and producing a plan for crop production.
